(19) United States
(12) Patent Application Publication
(10) Pub. No.: US 2026/0109023 A1
(43) Pub. Date: Apr. 23, 2026

(54) WEARABLE ROBOT

(71) Applicants: HYUNDAI MOTOR COMPANY, Seoul (KR); Kia Corporation, Seoul (KR)

(72) Inventors: Kyu Jung KIM, Hwaseong-si (KR); Seok Ryung KWON, Hwaseong-si (KR); Ju Young YOON, Hwaseong-si (KR); Beom Su KIM, Hwaseong-si (KR); Hyo Joong KIM, Hwaseong-si (KR); Seong Taek HWANG, Hwaseong-si (KR); Ho Jun KIM, Hwaseong-si (KR); Taek Seong JIN, Hwaseong-si (KR); Hyun Seop LIM, Hwaseong-si (KR); Min Woong JEUNG, Hwaseong-si (KR)

(73) Assignees: HYUNDAI MOTOR COMPANY, Seoul (KR); Kia Corporation, Seoul (KR)

(21) Appl. No.: 19/209,375

(22) Filed: May 15, 2025

(30) Foreign Application Priority Data
Oct. 21, 2024 (KR) 10-2024-0144379

(51) Int. Cl. B25J 9/00

(52) U.S. Cl. CPC B25J 9/0006

(57) ABSTRACT

A wearable robot includes an extension member, an assistive power generation member rotatably coupled to a first side of the extension member and configured to provide assistive power, and a support member rotatably coupled to a second side of the extension member and configured to be secured to one side of a body part of a wearer. The extension member includes a ball joint region provided at the second side, and the support member includes a socket region configured to define an accommodation space for accommodating the ball joint region. The ball joint region includes a protrusion section protruding outward from a surface of the ball joint region to prevent unintentional separation of the extension member from the support member and to restrict a rotatable range between the extension member and the support member.

### CROSS-REFERENCE TO RELATED APPLICATION

This application claims priority to and the benefit of Korean Patent Application No. 10-2024-0144379 filed with the Korean Intellectual Property Office on Oct. 21, 2024, the entire contents of which are incorporated herein by reference.

### TECHNICAL FIELD

The present disclosure relates to a wearable robot.

### BACKGROUND ART

A wearable robot, which provides assistive power to support the muscular strength of a person during a working process performed by the person, includes a torque generator configured to generate assistive power with different magnitudes depending on a posture of a wearer. For example, a wearable robot, which provides assistive power for assisting shoulder muscular strength of a person, is provided in the vicinity of a shoulder joint of the person provides the assistive power for assisting the shoulder muscular strength while corresponding to a relative rotation angle of the shoulder joint.

Meanwhile, the wearable robot, which assists the shoulder muscular strength, needs to have a region configured to be tightly attached to a body of the wearer in order to generate assistive power that varies depending on a change in posture of the person. For example, in the related art, the wearable robot, which assists the shoulder muscular strength, often has a pad member configured to be tightly attached to a waist of the wearer. That is, the pad member of the wearable robot is often rotatably coupled to a rod member, and the rod member is often rotatably coupled to the torque generator. The rod member and the pad member are often coupled by ball joint-ball socket coupling.

However, in the related art, there is a problem in that in case that a rotation angle between the rod member and the pad member exceeds a predetermined range, a region in which the ball socket and the ball joint are in contact with each other is damaged, or the ball socket and the ball joint are separated from each other regardless of the wearer's intention.

### SUMMARY

The present disclosure addresses the problem in which one of two components is damaged, or the two components unintentionally separate from each other, even if the rotation angle between the two rotatably coupled components in a wearable robot reaches a predetermined range.

In order to achieve the above-mentioned object, one aspect of the present disclosure provides a wearable robot including: an extension member; an assistive power generation member rotatably coupled to a first side of the extension member and configured to provide the extension member with assistive power in a second rotation direction, which is opposite to a first rotation direction, when the extension member rotates in the first rotation direction; and a support member rotatably coupled to a second side of the extension member and configured to be tightly attached to one side of a body part of a wearer, in which the extension member includes a ball joint region provided at the second side, in which the support member includes a socket region configured to define an accommodation space in which the joint region is accommodated, and in which the ball joint region includes a protrusion section having a shape protruding outward.

The protrusion section may have a closed-loop shape.

The ball joint region may further include a joint body section having at least a partial region with a spherical or ellipsoidal shape, and the protrusion section may be formed on a portion of a surface of the joint body section spaced apart inward from a center of the joint body section.

The socket region may include an inner recess surface configured to define a recessed space having a shape recessed inward from the accommodation space, and the wearable robot may further include an elastic member accommodated in the recessed space.

The elastic member may be elastically compressed in a state in which the ball joint region is accommodated in the socket region.

A partial region of the elastic member may be positioned within the accommodation space.

When a direction in which the extension member extends is defined as an axial direction A, an imaginary plane including the protrusion section may perpendicularly intersect the axial direction A in a state in which the ball joint region is perpendicularly fastened to the socket region.

A maximum spacing distance between the axial direction A and a surface of the joint body section may be longer than a maximum spacing distance between the axial direction A and a surface of the protrusion section in the state in which the ball joint region is perpendicularly fastened to the socket region.

When a direction in which the extension member extends is defined as an axial direction A, the protrusion section may be configured to interfere with the elastic member when the axial direction A is inclined at a predetermined angle relative to the socket region.

When a direction in which the extension member extends is defined as an axial direction A, the inner recess surface may include: a first inner surface section extending in a direction intersecting the axial direction A; a second inner surface section extending in the direction intersecting the axial direction A and spaced apart from the first inner surface section in a direction in which the axial direction A extends; and an inner surface connection section configured to connect the first inner surface section and the second inner surface section, and the inner surface connection section may include an inclined surface shape having a predetermined angle with respect to the axial direction A in a state in which the ball joint region is perpendicularly fastened to the socket region.

The inclined surface shape may have a shape inclined outward in a direction away from the accommodation space.

The elastic member may have an elastically compressed shape, and a long radius of the elastically compressed elastic member may be parallel to the inclined surface.

When a direction in which the extension member extends is defined as an axial direction A, a direction in which the recessed space is recessed may be inclined at a predetermined angle relative to a direction in which the axial direction A extends in a state in which the wearer wears the wearable robot.

According to the present disclosure, even if the rotation angle between the two components, which are rotatably coupled in the wearable robot that assists the muscular strength of the wearer, reaches the predetermined range, it is possible to prevent damage to one of the two components and solve the problem in which the two components are separated from each other regardless of the wearer's intention.

### BRIEF DESCRIPTION OF THE DRAWINGS

FIG. 1 is a perspective view of a wearable robot according to the present disclosure.

FIG. 2 is an enlarged view illustrating a region in which an extension member and a support member are coupled in the wearable robot according to the present disclosure.

FIG. 3 is a transparent view further illustrating an internal state of a socket region of the support member in FIG. 2.

FIG. 4 is an enlarged view illustrating a ball joint region illustrated in FIG. 3.

FIG. 5 is a view illustrating a state in which the ball joint region is separated from the socket region in the wearable robot according to the present disclosure.

FIG. 6 is a view illustrating a state in which interference occurs between a protrusion section and an elastic member in case that the extension member is inclined at a predetermined angle relative to the socket region in the wearable robot according to the present disclosure.

### DETAILED DESCRIPTION

Hereinafter, a wearable robot according to the present disclosure will be described with reference to the drawings.

### Wearable Robot

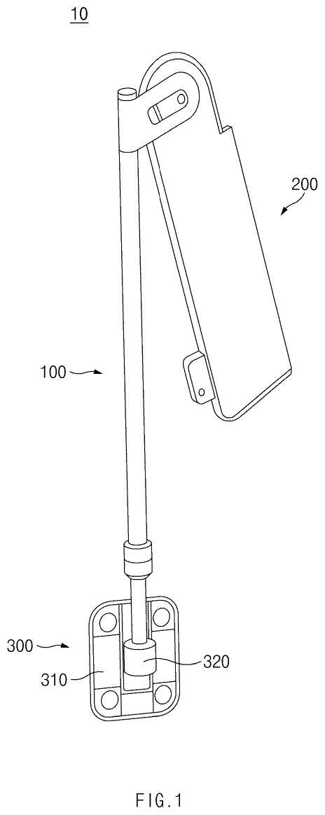

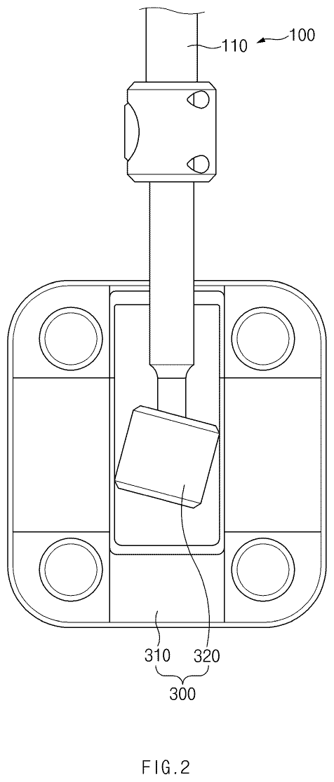

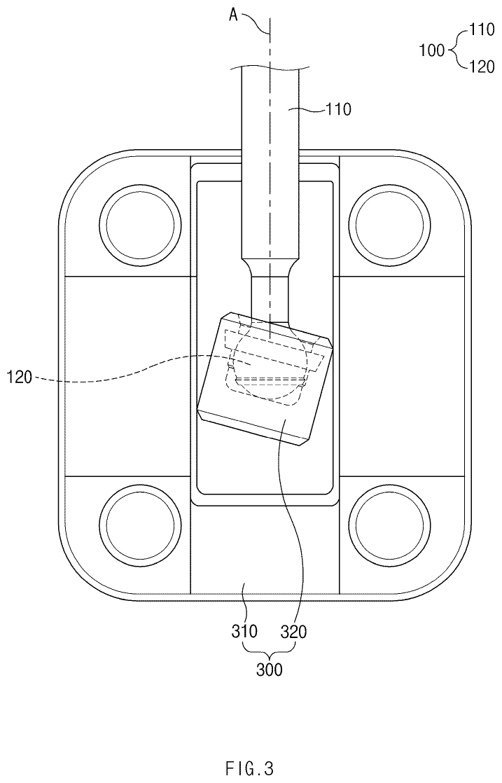

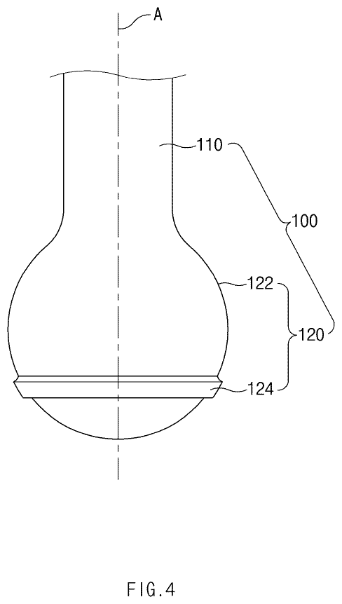

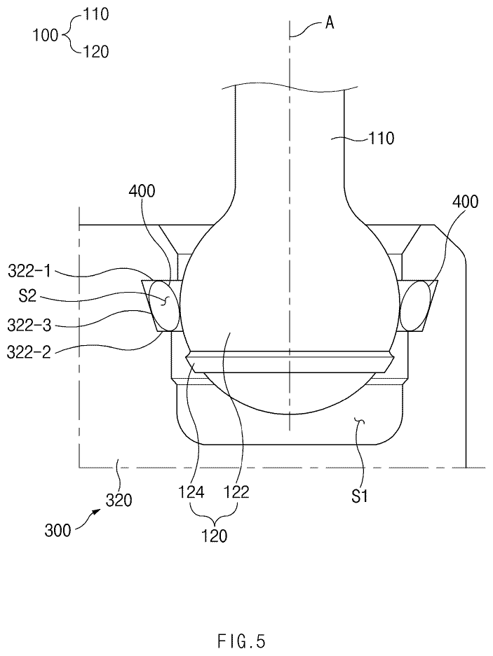

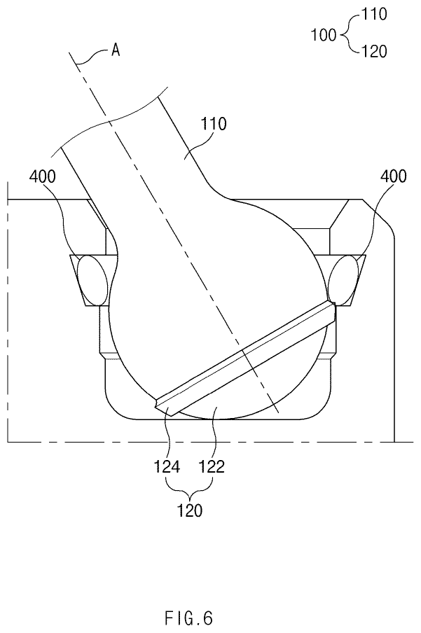

FIG. 1 is a perspective view of a wearable robot according to the present disclosure, and FIG. 2 is an enlarged view illustrating a region in which an extension member and a support member are coupled in the wearable robot according to the present disclosure. FIG. 3 is a transparent view further illustrating an internal state of a socket region of the support member in FIG. 2, and FIG. 4 is an enlarged view illustrating a ball joint region illustrated in FIG. 3. FIG. 5 is a view illustrating a state in which the ball joint region is separated from the socket region in the wearable robot according to the present disclosure, and FIG. 6 is a view illustrating a state in which interference occurs between a protrusion section and an elastic member in case that the extension member is inclined at a predetermined angle with respect to the socket region in the wearable robot according to the present disclosure.

With reference to FIGS. 1 to 6, a wearable robot 10 according to the present disclosure may be configured to assist muscular strength of a wearer. For example, the wearable robot 10 according to the present disclosure may be a device for assisting shoulder muscular strength and/or arm muscular strength of the wearer. In this case, the wearable robot 10 may provide assistive power for assisting shoulder muscular strength and/or arm muscular strength of the wearer while the wearer raises his/her arm.

As illustrated in FIGS. 1 and 3, the wearable robot 10 according to the present disclosure may include an extension member 100, an assistive power generation member 200 rotatably coupled to a first side of the extension member 100 and configured to provide the extension member 100 with assistive power in a second rotation direction, which is opposite to a first rotation direction, when the extension member 100 rotates in the first rotation direction, and a support member 300 rotatably coupled to a second side of the extension member 100 and tightly attached to one side of a body part of the wearer. For example, the support member 300 may be configured to be tightly attached to a waist of the wearer. In addition, for example, one side of the assistive power generation member 200 may be configured to be tightly attached to an upper arm or elbow of the wearer.

Meanwhile, the extension member 100 and the support member 300 according to the present disclosure may be rotatably coupled to each other by joint-socket coupling.

More specifically, the extension member 100 may include an extension body region 110 configured to define a body of the extension member and including the first side, and a ball joint region 120 connected to one end of the extension body region 110 and provided at the second side. In addition, the support member 300 may include a pad region 310 configured to be tightly attached directly to one side of the body part of the wearer, and a socket region 320 fixed to one side of the pad region 310 and configured to define an accommodation space S1 in which the ball joint region 120 is accommodated. Meanwhile, the extension body region 110 may have a rod shape as a whole.

Meanwhile, according to the present disclosure, the wearable robot may further include a configuration for preventing the extension member 100 and the support member 300 from being uncoupled regardless of the wearer's intention while restricting a rotatable angle between the extension member 100 and the support member 300.

More specifically, according to the present disclosure, the ball joint region 120 may include a protrusion section 124 having a shape protruding outward. As described below, the protrusion section 124 may serve to prevent the extension member 100 and the support member 300 from being uncoupled regardless of the wearer's intention while restricting the rotatable angle between the extension member 100 and the support member 300 by means of physical interference with the socket region 320. For example, the protrusion section 124 may have a closed-loop shape. Alternatively the above-mentioned configuration, the protrusion section 124 may have an open-loop shape. For example, when a direction in which the extension member 100 extends, more specifically, a direction in which the extension body region 110 extends is defined as an axial direction A, an imaginary plane including the protrusion section 124 may perpendicularly intersect the axial direction A in a state in which the ball joint region 120 is perpendicularly fastened to the socket region 320.

Meanwhile, as illustrated in FIG. 4, the ball joint region 120 may further include a joint body section 122 having at least a partial region with a spherical or elliptical shape. In this case, the protrusion section 124 may have a shape protruding outward from a surface of the joint body section 122. More specifically, as illustrated in FIGS. 4 and 5, the protrusion section 124 may be formed on a portion of the surface of the joint body section 122 spaced apart inward from a center of the joint body section 122. It may be understood that the protrusion section 124 is positioned below the center of the joint body section 122 based on FIGS. 4 and 5.

With continued reference to FIGS. 5 and 6, an additional space may be formed in the socket region 320 according to the present disclosure, in addition to the accommodation space S1. More specifically, the socket region 320 may include an inner recess surface 322 configured to define a recessed space S2 having a shape recessed inward from the accommodation space S1. In this case, the wearable robot 10 according to the present disclosure may further include an elastic member 400 accommodated in the recessed space S2. As described below, the elastic member 400 may be configured to physically interfere with the protrusion section 124. More particularly, the elastic member 400 may be elastically compressed in the state in which the ball joint region 120 is accommodated in the socket region 320. According to the present disclosure, in the state in which the ball joint region 120 is accommodated in the socket region 320, the majority of the elastic member 400 is positioned in the recessed space S2, and a partial region of the elastic member 400 may be positioned in the accommodation space S1. This may be to implement a configuration in which the elastic member 400 is stably accommodated in the recessed space S2, and a part of the elastic member 400 may protrude from the recessed space S2 and interfere with the protrusion section 124.

In addition, as illustrated in FIGS. 4 and 5, according to the present disclosure, in the state in which the ball joint region 120 is perpendicularly fastened to the socket region 320, a maximum spacing distance between the axial direction A and the surface of the joint body section 122 may be longer than a maximum spacing distance between the central axis A and the surface of the protrusion section 124.

In case that the wearer pulls the extension member 100 in a direction away from the socket region 320 in the state in which the ball joint region 120 is perpendicularly fastened to the socket region 320, i.e., in the state in which the extension member 100 is not inclined with respect to the socket region 320, a convex surface of the ball joint region 120, which has at least a partial region with a spherical or ellipsoidal shape, may softly pass over the elastic member 400, such that the wearer may smoothly uncouple the extension member 100 and the socket region 320. In this case, as described above, in order to prevent the occurrence of interference between the protrusion section 124 and the elastic member 400 during the process in which the wearer uncouples the extension member 100 and the socket region 320, the maximum spacing distance between the axial direction A and the surface of the joint body section 122 may be longer than the maximum spacing distance between the central axis A and the surface of the protrusion section 124 in the state in which the ball joint region 120 is perpendicularly fastened to the socket region 320. Meanwhile, it may be understood that in the present specification, the state in which the ball joint region is perpendicularly fastened to the socket region means a state in which the axial direction A is parallel to the direction in which the recessed space S is recessed from the outside of the socket region 320, as illustrated in FIG. 5.

The protrusion section 124 may be configured to interfere with the elastic member 400 in case that the axial direction A is inclined at a predetermined angle with respect to the socket region 320. Therefore, according to the present disclosure, in case that the extension member 100 is inclined at the predetermined angle with respect to the socket region 320, a rotatable range of the extension member 100 relative to the socket region 320 may be restricted by the interference between the protrusion section 124 and the elastic member 400.

With reference to FIGS. 5 and 6, the above-mentioned inner recess surface 322 may include a plurality of sections. More specifically, the inner recess surface 322 may include a first inner surface section 322-1 extending in a direction intersecting the axial direction A, a second inner surface section 322-2 extending in the direction intersecting the axial direction A and spaced apart from the first inner surface section 322-1 in a direction in which the axial direction A extends, and an inner surface connection section 322-3 configured to connect the first inner surface section 322-1 and the second inner surface section 322-2.

In this case, according to the present disclosure, in the state in which the ball joint region 120 is perpendicularly fastened to the socket region 320, the inner surface connection section 322-3 may include an inclined surface shape having a predetermined angle with respect to the axial direction A. One side surface of the elastic member 400 may be tightly attached to the inner surface connection section 322-3. Therefore, in case that the inner surface connection section 322-3 has the above-mentioned inclined surface shape, the elastic member 400 may also be kept in an obliquely and elastically compressed state. More specifically, the elastic member 400 may have the elastically compressed shape, as described above. A long radius of the elastically compressed elastic member 400 may be parallel to the above-mentioned inclined surface. In particular, the inclined surface may slope outward in a direction away from the accommodation space S1, i.e., away from the axial direction A.

Meanwhile, according to the present disclosure, in the state in which the wearer wears the wearable robot 10 according to the present disclosure, the direction in which the recessed space S2 is recessed may be inclined at a predetermined angle with respect to the direction in which the axial direction A extends. It may be understood that the socket region 320 is structured to be inclined toward one side based on the state in which the wearer wears the wearable robot 10. In this case, an operable range, which is the rotatable range of the extension member 100 relative to the socket region 320, may be inclined in one direction with respect to the vertical direction. In this case, the ball joint region 120 is not perpendicularly fastened to the socket region 320 in the state in which the wearer wears the wearable robot 10.

The present disclosure has been described with reference to the limited embodiments and the drawings, but the present disclosure is not limited thereby. The present disclosure may be embodied in various forms by those skilled in the art, within the spirit and scope of the appended claims.

What is claimed is:

1. A wearable robot comprising:
an extension member;
an assistive power generation member rotatably coupled to a first side of the extension member and configured to provide the extension member with assistive power in a second rotation direction, which is opposite to a first rotation direction, when the extension member rotates in the first rotation direction; and
a support member rotatably coupled to a second side of the extension member and configured to be secured to one side of a body part of a wearer,
wherein the extension member comprises a ball joint region provided at the second side,
wherein the support member comprises a socket region configured to define an accommodation space in which the ball joint region is accommodated and
wherein the ball joint region comprises a protrusion section having a shape protruding outward.

2. The wearable robot of claim 1, wherein the protrusion section is in a closed-loop shape.

3. The wearable robot of claim 1, wherein the ball joint region further comprises a joint body section having at least a partial region with a spherical or ellipsoidal shape and
wherein the protrusion section is formed on a portion of a surface of the joint body section spaced apart inward from a center of the joint body section.

4. The wearable robot of claim 1, wherein the socket region comprises an inner recess surface configured to define a recessed space recessed inward from the accommodation space and
wherein the wearable robot further comprises an elastic member accommodated in the recessed space.

5. The wearable robot of claim 4, wherein the elastic member is elastically compressed when the ball joint region is accommodated in the socket region.

6. The wearable robot of claim 4, wherein a partial region of the elastic member is positioned within the accommodation space.

7. The wearable robot of claim 4, wherein when a direction in which the extension member extends is defined as an axial direction A, an imaginary plane including the protrusion section perpendicularly intersects the axial direction A when the ball joint region is perpendicularly fastened to the socket region.

8. The wearable robot of claim 7, wherein a maximum spacing distance between the axial direction A and a surface of the joint body section is greater than a maximum spacing distance between the axial direction A and a surface of the protrusion section when the ball joint region is perpendicularly fastened to the socket region.

9. The wearable robot of claim 4, wherein when a direction in which the extension member extends is defined as an axial direction A, the protrusion section is configured to interfere with the elastic member when the axial direction A is inclined at a predetermined angle relative to the socket region.

10. The wearable robot of claim 4, wherein when a direction in which the extension member extends is defined as an axial direction A, the inner recess surface comprises:
a first inner surface section extending in a direction intersecting the axial direction A;
a second inner surface section extending in the direction intersecting the axial direction A and spaced apart from the first inner surface section in a direction in which the axial direction A extends; and
an inner surface connection section configured to connect the first inner surface section and the second inner surface section and
wherein the inner surface connection section comprises an inclined surface having a predetermined angle with respect to the axial direction A when the ball joint region is perpendicularly fastened to the socket region.

11. The wearable robot of claim 10, wherein the inclined surface has a shape inclined outward in a direction away from the accommodation space.

12. The wearable robot of claim 11, wherein the elastic member has an elastically compressed shape, and a long radius of the elastically compressed elastic member is parallel to the inclined surface.

13. The wearable robot of claim 4, wherein when a direction in which the extension member extends is defined as an axial direction A, a direction in which the recessed space is recessed is inclined at a predetermined angle relative to a direction in which the axial direction A extends when the wearer wears the wearable robot.
